(19) United States
(12) Patent Application Publication
(10) Pub. No.: US 2018/0219288 A1
(43) Pub. Date: Aug. 2, 2018

(54) Wideband Dielectrically Loaded Rectangular Waveguide to Air-filled Rectangular Waveguide Adapter

(71) Applicants: Michael Benjamin Griesi, Gilbert, AZ (US); Thomas Anthony Mcdonough, Columbia, SC (US); Paul Gordon Huray, Georgetown, SC (US)

(72) Inventors: Michael Benjamin Griesi, Gilbert, AZ (US); Thomas Anthony Mcdonough, Columbia, SC (US); Paul Gordon Huray, Georgetown, SC (US)

(21) Appl. No.: 15/880,534

(22) Filed: Jan. 26, 2018

Related U.S. Application Data
(60) Provisional application No. 62/451,812, filed on Jan. 30, 2017.

(51) Int. Cl. H01Q 5/15; H01Q 1/38

(52) U.S. Cl. CPC H01Q 5/15; H01Q 1/38

(57) ABSTRACT

A dielectrically loaded rectangular waveguide to air-filled rectangular waveguide adapter and right-angle waveguide probe antenna with a bandwidth greater than 15% of the center frequency of the operating band, as defined by a return loss over the frequency range better than or equal to −20 dBV. This invention is most relevant to a right-angle coaxial to a dielectrically loaded rectangular waveguide, followed by an air-filled rectangular waveguide transition. The dielectrically loaded rectangular waveguide to air-filled rectangular waveguide adapter is comprised of a relatively narrow dielectrically loaded rectangular waveguide section, a relatively wide air-filled rectangular waveguide section following the dielectrically loaded rectangular waveguide section of equal height, and a right-angle waveguide probe antenna. The probe antenna is comprised of a tapered cylinder that results in an inverted conical shape resembling a V-frame. The resultant “V-frame probe” is connected to a coaxial feed cable and extends into the dielectrically loaded waveguide section through an aperture. The dielectrically loaded waveguide transitions into an air-filled rectangular waveguide and is sized such that it the impedance of the dominant TE mode of frequencies supported by the waveguide is preserved without causing unintended mode conversion. The V-frame probe operates as a TE10 mode waveguide radiator, and is sized and positioned such that the impedance of the probe antenna is closely matched to the impedance of the waveguide across a wider frequency band.

### CROSS-REFERENCE TO RELATED APPLICATIONS

Provisional Patent: U.S. 62/451,812

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to rectangular waveguide adapters, and more specifically, to a coaxial cable fed dielectrically loaded rectangular waveguide to air-filled rectangular waveguide adapter with probe antenna for transmitting and receiving the dominant TE mode.

### Background of the Invention

Calculating the cutoff frequency of a rectangular waveguide is well known for both air-filled and dielectrically loaded rectangular waveguides [D. Pozar, Microwave Engineering, 4th ed., Hoboken, N.J.: Wiley, 2012, pp. 113]. Calculating the dimensions of a rectangular waveguide with a particular cutoff frequency is therefore trivial in either instance.

Logic would follow that transitioning from a coaxial cable fed dielectrically loaded rectangular waveguide to air-filled rectangular waveguide would likewise be trivial, yet this is not the case. Properly designing the dielectrically loaded rectangular waveguide such that the abrupt change in impedance to an air-filled rectangular waveguide does not cause unintended return loss or mode conversion does not follow the conventional calculations and is therefore not obvious.

However, in some applications, such a transition is desirable. Thus, there exists a need for a coaxial cable fed dielectrically loaded rectangular waveguide to air-filled rectangular waveguide adapter.

Furthermore, rectangular waveguides conventionally provide a narrow bandwidth of operation, typically less than 15% when defined by a return loss over the frequency range better than or equal to −20 dBV. The frequency and/or frequency range of operation is determined by the frequencies at which the impedance of the probe antenna is matched to the impedance of the waveguide [R. Collin, Field Theory of Guided Waves. McGraw-Hill, 1960, pp. 258-271], provided the frequency and/or frequencies are above the cutoff frequency of the waveguide.

However, in some applications, a larger bandwidth is more desirable. The solution to this problem is not trivial and has, until now, remained elusive. Thus, there also exists a need for a wideband coaxial to waveguide probe antenna for a dielectrically loaded waveguide which transitions to an air-filled rectangular waveguide.

### Background Art

U.S. Pat. No. 5,122,390, patented Jun. 16, 1992 by first inventor Charles C. Rearick, reveals manufacturing methods to uniformly coat a probe for use in a coaxial to waveguide transition in a dielectric material. While the cited existing art provides a manufacturing approach to coating a probe in a dielectric material, it does not provide a method for coupling a dielectrically loaded rectangular waveguide to an air-filled rectangular waveguide and therefore cannot address the abrupt change in impedance between mediums that would cause unintended return loss or mode conversion. Furthermore, the cited existing art does not provide a method of designing the probe such that the bandwidth is increased beyond or even with the conventional bandwidth of operation for a coaxial to waveguide transition.

### BRIEF SUMMARY OF THE INVENTION

The following is intended to be a brief summary of the invention and is not intended to limit the scope of the invention.

With the stated background of the invention in mind, it is an object of this invention to provide a coaxial cable fed dielectrically loaded rectangular waveguide to air-filled rectangular waveguide adapter which does not cause unintended return loss or mode conversion.

It is also an object of this invention to provide a right-angle waveguide probe antenna, which can accompany the dielectrically loaded rectangular waveguide to air-filled rectangular waveguide transition, with a bandwidth greater than 15% of the center frequency of the operating band, defined by a return loss over the frequency range better than or equal to −20 dBV.

The first object of this invention is attained generally by designing the shape of the dielectrically loaded rectangular waveguide section such that it is capable of matching, or closely matching, the impedance of the air-filled rectangular waveguide section for the dominant TE mode of frequencies supported by the waveguide. The embodiment of this component of the invention is characterized by properly sizing the broad wall dimension of the dielectrically loaded waveguide such that the return loss across the operating frequency band is better than or equal to −20 dBV and the dominant TE10 mode is preserved. For both the dielectrically loaded and air-filled components of the waveguide, a conducting shell, typically aluminum, completely encloses all corresponding walls. The second object of this invention is attained generally by designing the shape of the probe antenna such that it is capable of matching, or closely matching, the impedance of the probe antenna to the impedance of the waveguide across a wide band of frequencies. The embodiment of this component of the invention is characterized by a conducting structure, typically copper, and is formed such that the probe antenna decreases in diameter with respect to the diameter of the coaxial feed center conductor. The largest diameter of the probe antenna will be equal to the diameter of the coaxial feed center conductor, while the smallest diameter of the probe antenna will be determined by the desired increase in bandwidth. The tapered section will reach a depth necessary to match the impedance of the probe antenna to the impedance of the waveguide across the desired frequency band, resulting in an inverted conical shape with a ball point resembling a V-frame. Finally, the probe will be positioned such that the distance to the back wall (or backshort) of the waveguide is set to match the impedance of the probe antenna to the impedance of the waveguide across the desired frequency band.

### BRIEF DESCRIPTION OF THE SEVERAL VIEWS OF THE DRAWING(S)

Note: For simplicity of illustration, any mounting hardware related to affixing a coaxial cable to a rectangular waveguide of common industry hardware are not depicted as they are generally known to those with skill in the art, and more importantly do not impact performance as the hardware is external to the invention disclosed.

FIG. 1 is an isometric drawing of the dielectrically loaded rectangular waveguide to air-filled rectangular waveguide adapter, along with the wideband V-frame waveguide probe antenna, connected to the center conductor of a coaxial feed and positioned within the dielectrically loaded rectangular waveguide.

FIG. 2 is a top-down view of the dielectrically loaded rectangular waveguide to air-filled rectangular waveguide adapter, along with the wideband V-frame waveguide probe antenna, connected to the center conductor of a coaxial feed and positioned within the dielectrically loaded rectangular waveguide.

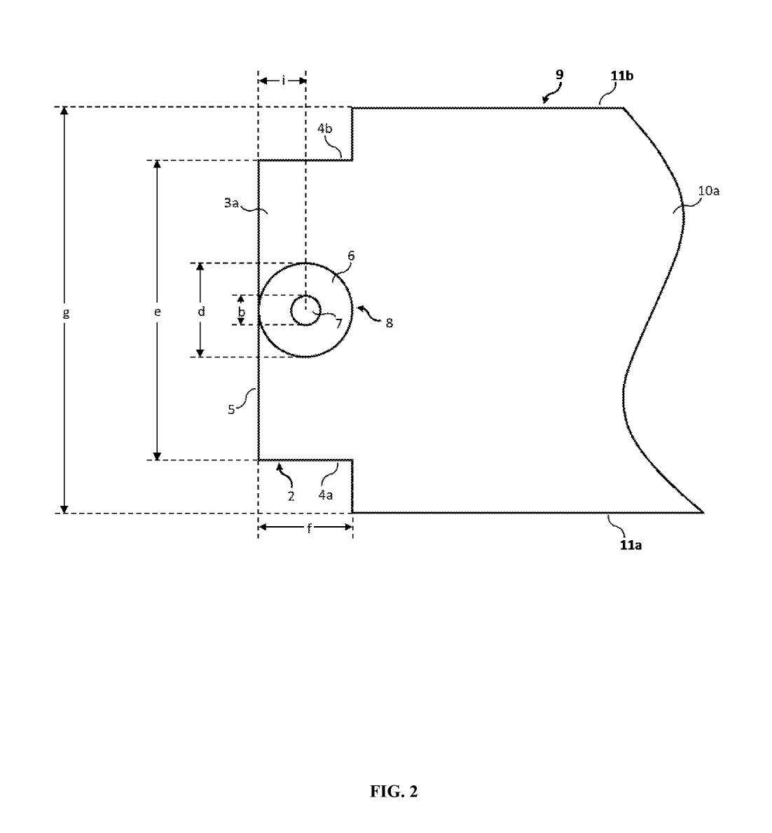

FIG. 3 is a cross-sectional view of the dielectrically loaded rectangular waveguide to air-filled rectangular waveguide adapter, along with the wideband V-frame waveguide probe antenna, connected to the center conductor of a coaxial feed and positioned within the dielectrically loaded rectangular waveguide.

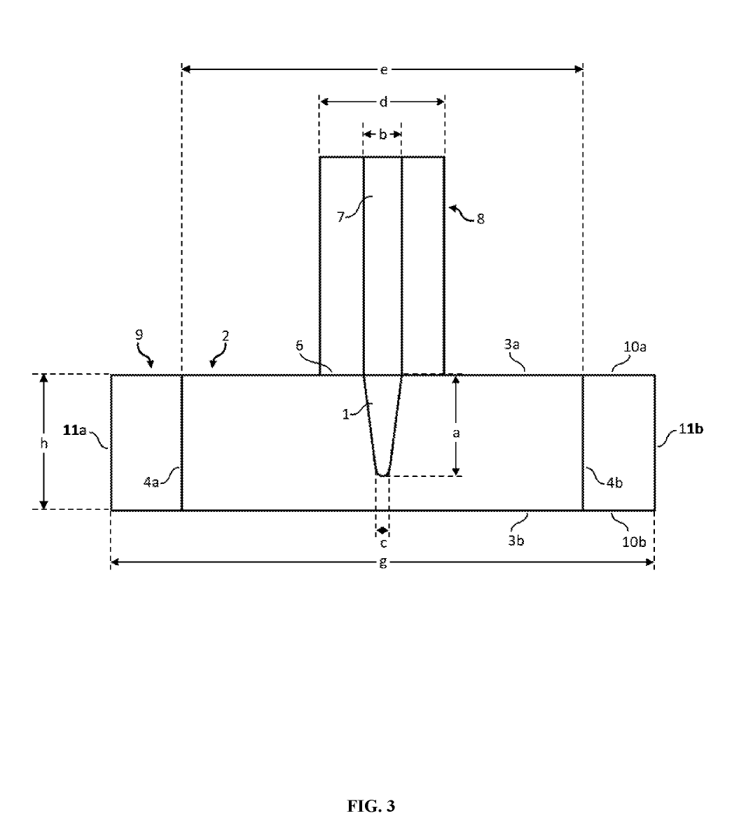

FIG. 4 shows the insertion and return loss performance of the dielectrically loaded rectangular waveguide to air-filled rectangular waveguide adapter, including the wideband V-frame waveguide probe antenna.

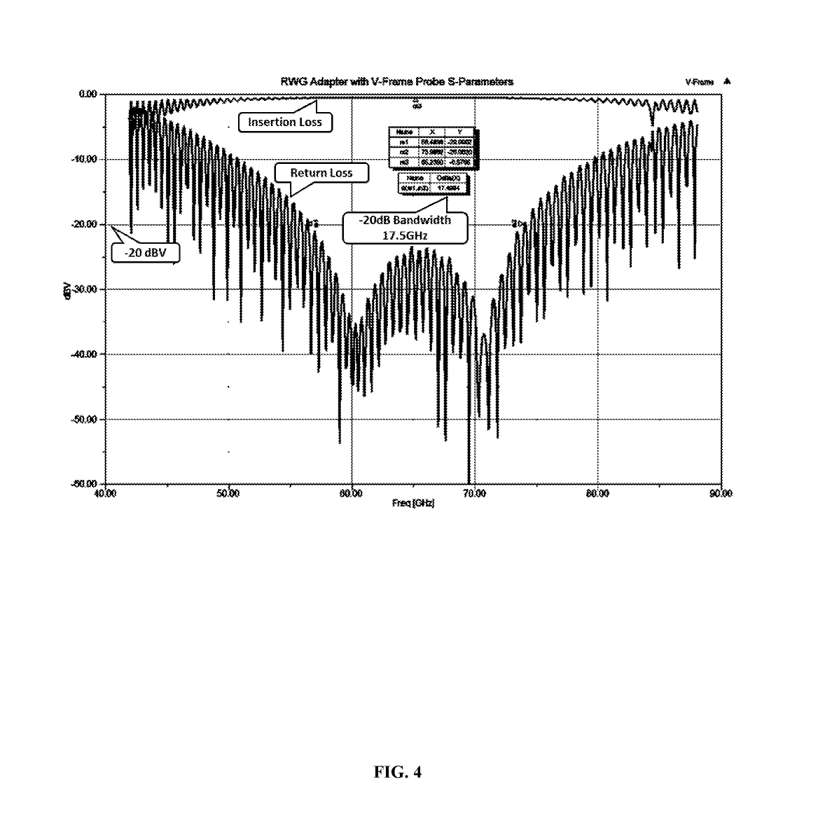

### DETAILED DESCRIPTION OF THE INVENTION

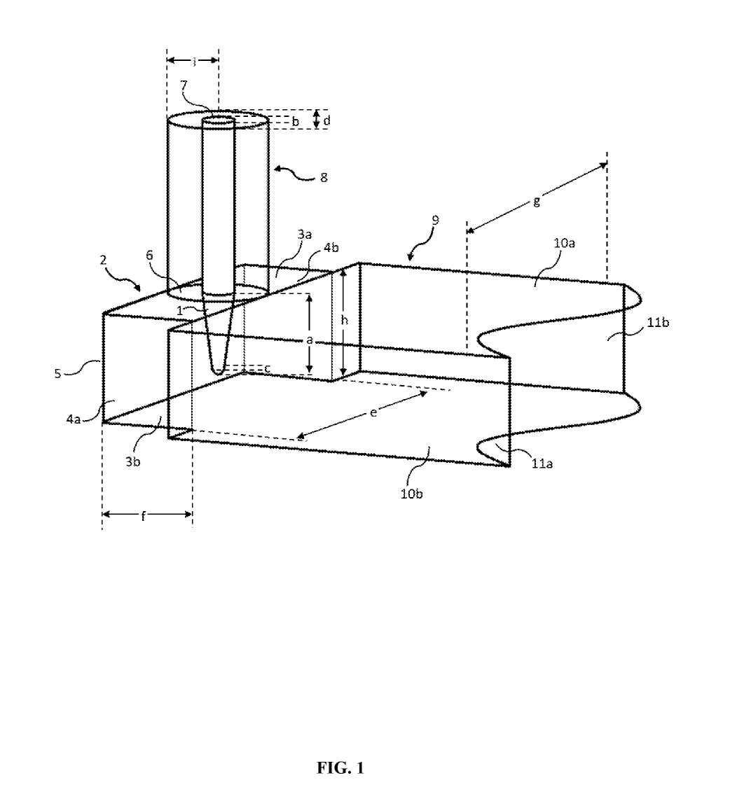

Referring to FIG. 1, a wideband V-frame waveguide probe antenna 1 (hereinafter sometimes referred to simply as V-frame probe) is shown within the dielectrically loaded waveguide section 2 having a pair of broad walls 3a and 3b, a pair of narrow walls 4a and 4b, and a short circuited end (or backshort) 5. The V-frame probe extends into the dielectrically loaded waveguide section 2, through an aperture 6 in one of the broad walls 3a, and is attached to the center conductor 7 of a coaxial feed cable 8.

The coaxial feed cable 8 (between the inner and out conductors) and dielectrically loaded waveguide section 2 are filled with a dielectric material. The transition between the coaxial feed cable 8 dielectric fill material and dielectrically loaded waveguide section 2 dielectric fill material is continuous.

The dielectrically loaded waveguide section 2 connects to an air-filled rectangular waveguide section 9 having a pair of broad walls 10a and 10b, a pair of narrow walls 11a and 11b.

The V-frame probe 1 and coaxial feed center conductor 7 are made of copper. The coaxial feed outer conductor and waveguide walls 3a, 3b, 4a, 4b, 10a, 10b, 11a, 11b, and 5 are made of aluminum.

The overall length of the V-frame probe 1 is approximately 0.9356 mm, as measured from the interior of the broad wall 3a at the center point of the aperture 6.

The wide diameter at the top of the V-frame probe 1 which is connected to the center conductor of the coaxial teed cable 7 is approximately 0.36 mm, which is equal to the diameter of the center conductor of the coaxial feed cable 7.

The narrow diameter at the bottom of the V-frame probe 1 is approximately 0.1224 mm, which is terminated with a ball point with a diameter equal to the narrow diameter of the bottom of the V-frame probe.

The broad walls 3a and 3b of the dielectrically loaded waveguide section 2 are approximately 3.6974 mm wide. The length of the dielectrically loaded waveguide section 2 is approximately 1.152 mm.

The interior of the broad walls 10a and 10b of the air-filled waveguide section 9 are approximately 4.997 mm wide.

The air-filled waveguide section 9 connects directly to the dielectrically loaded waveguide section 2. Both waveguide section's 2 and 9 narrow walls 4a, 4b, 11a, and 11b share the same height of approximately 1.249 mm.

The center of the V-frame probe 1 is approximately 0.576 mm away from the back wall (or backshort) of the dielectrically loaded waveguide section 5 and in the center of the broad wall 3a dimension.

The diameter of the aperture 6 is approximately 0.576 mm and the relative permittivity of the dielectric within the coaxial cable between the center and outer conductor is 2.08. The outer diameter of the dielectric within the coaxial cable (and coincident inner diameter of the coaxial cable outer conductor) is equal to the diameter of the aperture 6. The characteristic impedance of the coaxial cable is therefore approximately 50 Ohms. The dielectrically loaded waveguide section 2 is filled with the same dielectric material as the coaxial cable feed 8 dielectric fill material, and thus has a relative permittivity of 2.08.

The specific embodiment of this invention has demonstrated a bandwidth of up to 26.9% for a symmetric center frequency across the band of operation of 65 GHz. The resulting 17.5 GHz bandwidth, thus, ranges from approximately 56.5 GHz to 74 GHz. In operation, the V-frame probe antenna operates as a TE10 mode waveguide radiator within or across the frequency band of operation.

The dimensions of the V-frame probe just mentioned were:

a=0.9356 mm

b=0.36 mm

c=0.1224 mm

d=1.152 mm

e=3.6974 mm

f=1.152 mm

g=4.997 mm

h=1.249 mm

i=0.576 mm

Having described a specific embodiment of this invention, it is now evident that other embodiments incorporating its concepts may be used. For example, the antenna element could be a conventional cylindrical monopole or the antenna element could be fed by an alternative feed network, such as a planar trace. Also, it will be apparent to those skilled in the art that various modifications and variations of the present invention's parameters can be made to achieve differing amounts of bandwidth without departing from the scope or spirit of the invention. Thus, this invention should not be restricted to its disclosed embodiment, but rather it is intended that the present invention covers such modifications and variations as come within the scope of the appended claims and their equivalents.

The invention claimed is:

1. A dielectrically loaded rectangular waveguide to air-filled rectangular waveguide adapter comprising:
a. a relatively narrow dielectrically loaded rectangular waveguide section;
b. a relatively wide air-filled rectangular waveguide section following the dielectrically loaded rectangular waveguide section of equal height; and
c. a uniformly tapered right-angle waveguide probe antenna with a ball point resulting in an inverted conical shape resembling a V-frame centered along the broad wall of the dielectrically loaded rectangular waveguide section.

2. A dielectrically loaded rectangular waveguide to air-filled rectangular waveguide adapter as recited in claim 1, characterized by a bandwidth greater than 15% of the center frequency of the operating band as defined by a return loss over the frequency range better than or equal to −20dBV.

3. A dielectrically loaded rectangular waveguide to air-filled rectangular waveguide adapter as recited in claim 1, in which the minimum radius of the V-frame taper in the dielectrically loaded rectangular waveguide section is adjustable or otherwise tunable.
